(19) United States
(12) Patent Application Publication
(10) Pub. No.: US 2022/0301045 A1
(43) Pub. Date: Sep. 22, 2022

(54) WAGON RENTAL SYSTEM

(71) Applicant: HONDA MOTOR CO., LTD., Tokyo (JP)

(72) Inventor: Itsuo YOSHIDA, Saitama (JP)

(21) Appl. No.: 17/683,985

(22) Filed: Mar. 1, 2022

(30) Foreign Application Priority Data
Mar. 16, 2021 (JP) 2021-041940

(51) Int. Cl. G06Q 30/06; G06Q 50/30

(52) U.S. Cl. CPC G06Q 30/0645; G06Q 50/30

(57) ABSTRACT

A wagon rental system includes: a management server; a plurality of user vehicles held by users; a plurality of wagons held at a station; a user vehicle controller provided in each user vehicle; a wagon controller provided in each wagon and configured to communicate with the management server and the user vehicle controller; and a user terminal configured to receive an input by each user and transmit a signal corresponding to the input by the user to the management server. The management server is configured to create a use plan for the wagon based on use application information from the user terminal and transmit the use plan to the wagon controller, and the wagon controller is configured to cause the wagon to follow the user vehicle based on the use plan when the user vehicle is within a prescribed range from the wagon.

### TECHNICAL FIELD

The present invention relates to a wagon rental system.

### BACKGROUND ART

There are various types and sizes of vehicles depending on their purposes. Accordingly, a user commonly owns plural types of vehicles suitable for the respective purposes. For example, a farmer may own a transport vehicle such as a truck to transport work tools and crops as well as a relatively compact vehicle for his/her movement. However, such a transport vehicle is not used so frequently, and thus it may be burdensome for the user to individually own one. To deal with such a problem, JP2017-41194A discloses a car sharing system that rents out various vehicles such as a truck to the user.

However, in a case where the user rents the transport vehicle, it may take time for the user to get used to the operation of the transport vehicle. Further, in a case where the materials and tools necessary for work are loaded on the vehicle owned by the user, the user may need to move these tools or the like to the transport vehicle the user has rented. Further, the user tends to feel comfortable with an own vehicle and thus would like to use the own vehicle as frequently as possible. In this way, there are various inconveniences when the user uses the vehicle he/she has rented. In order to eliminate these inconveniences, a rental system for a wagon configured to follow the vehicle owned by the user is desired.

### SUMMARY OF THE INVENTION

In view of the above background, an object of the present invention is to provide a wagon rental system that can rent out a wagon configured to follow a user vehicle.

To achieve such an object, one aspect of the present invention provides a wagon rental system (1), comprising: a management server (2); a plurality of user vehicles (3) held by users; a plurality of wagons (5) held at a station (4); a user vehicle controller (6) provided in each user vehicle; a wagon controller (7) provided in each wagon and configured to communicate with the management server and the user vehicle controller; and a user terminal (8) configured to receive an input by each user and transmit a signal corresponding to the input by the user to the management server, wherein the management server is configured to create a use plan for the wagon based on use application information from the user terminal and transmit the use plan to the wagon controller, and the wagon controller is configured to cause the wagon to follow the user vehicle based on the use plan when the user vehicle is within a prescribed range from the wagon.

According to this aspect, it is possible to provide a wagon rental system that can rent out a wagon configured to follow a user vehicle. The user rents the wagon as needed and causes the wagon to follow the user vehicle held by the user, thereby enhancing the ability to transport a cargo. The user can drive the user vehicle, thereby comfortably transporting the cargo.

In the above aspect, preferably, the wagon controller and the user vehicle controller each have an identification code, and identify each other based on the identification code.

According to this aspect, the wagon can properly follow the user vehicle of the user who has made a request to rent the wagon.

In the above aspect, preferably, the wagon controller is configured to stop the wagon from following the user vehicle based on the signal from the user terminal.

According to this aspect, the user can stop the wagon from following the user vehicle by operating the user terminal.

In the above aspect, preferably, the management server is configured to create a travel plan based on the signal from the user terminal and transmit the travel plan to the wagon controller, the travel plan being created for causing the wagon to travel autonomously to a prescribed destination, and the wagon controller is configured to cause the wagon to travel autonomously to the destination based on the travel plan.

According to this aspect, the user can move the wagon to a prescribed destination by operating the user terminal. Accordingly, for example, it is possible to cause the wagon to travel autonomously to the station and thus return the wagon to the station. Further, it is possible to move the wagon to the place where the user vehicle is present. Further, it is possible to automatically move the cargo loaded on the wagon to a prescribed destination.

In the above aspect, preferably, the user terminal includes at least one of an onboard terminal provided in the user vehicle and a smartphone.

According to this aspect, the user can operate the wagon while in the user vehicle.

In the above aspect, preferably, the wagon includes a cargo monitoring sensor (61, 66) configured to monitor a cargo loaded on the wagon, and the wagon controller is configured to transmit, to the management server, information on a state of the cargo acquired by the cargo monitoring sensor, and the management server is configured to determine an abnormality of the cargo based on the information on the state of the cargo.

According to this aspect, the management server can detect that the cargo loaded on the wagon has fallen or has been stolen. The management server transmits information on the abnormality of the cargo to the user terminal, so that the user can recognize the falling or the like of the cargo.

In the above aspect, preferably the cargo monitoring sensor includes a scale (61) configured to measure a weight of the cargo, and the wagon controller is configured to transmit the weight of the cargo to the management server at prescribed time intervals.

According to this aspect, the management server can detect the abnormality of the cargo based on a change in the weight of the cargo.

In the above aspect, preferably, the cargo monitoring sensor includes a cover sensor (66) configured to detect an open/close state of a cover configured to cover the cargo, and the wagon controller is configured to transmit the open/close state of the cover to the management server at prescribed time intervals.

According to this aspect, the management server can detect the abnormality of the cargo based on the open/close state of the cover.

Thus, according to the above aspects, it is possible to provide a wagon rental system that can rent out a wagon configured to follow a user vehicle.

### BRIEF DESCRIPTION OF THE DRAWING(S)

FIG. 1 is a block diagram of a wagon rental system according to an embodiment;

FIG. 2 is a side view of a user vehicle and a wagon;

FIG. 3 is a block diagram of the user vehicle and the wagon;

FIG. 4 is a block diagram of a management server; and

FIG. 5 is a block diagram of a wagon rental system according to a modified embodiment.

### DETAILED DESCRIPTION OF THE INVENTION

<Wagon Rental System 1>

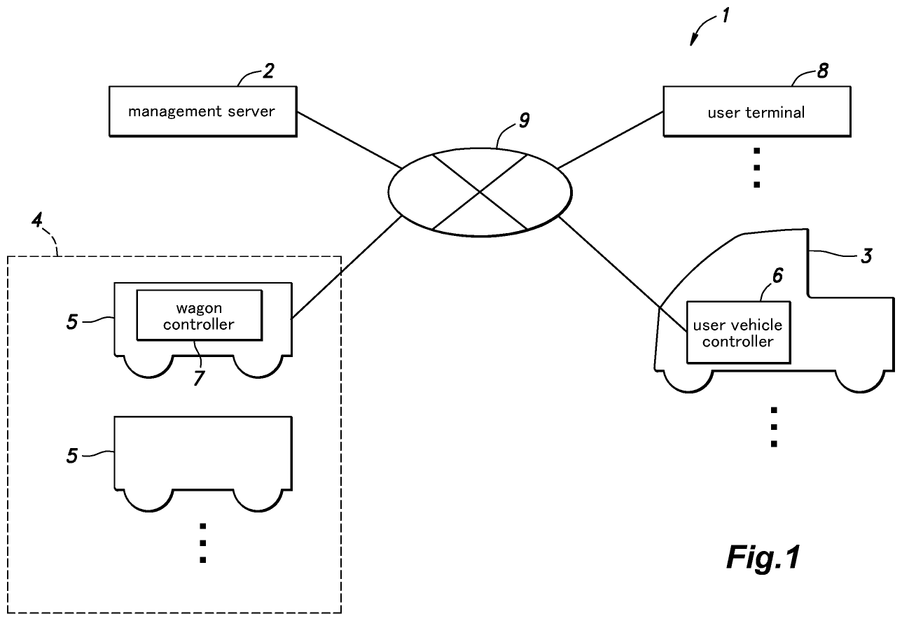

Hereinafter, a wagon rental system 1 according to an embodiment of the present invention will be described with reference to the drawings. As shown in FIG. 1, the wagon rental system 1 includes: a management server 2; a plurality of user vehicles 3 held by users; a plurality of wagons 5 held at a station 4; a user vehicle controller 6 provided in each user vehicle 3; a wagon controller 7 provided in each wagon 5 and configured to communicate with the management server 2 and the user vehicle controller 6; and a user terminal 8 configured to receive an input by each user and transmit a signal corresponding to the input by the user to the management server 2. The management server 2, the user terminal 8, the user vehicle controller 6, and the wagon controller 7 communicate with each other via the Internet 9. Incidentally, the user vehicle controller 6 is provided in each user vehicle 3, and thus the wagon rental system 1 includes a plurality of user vehicle controllers 6 in total. The wagon controller 7 is provided in each wagon 5, and thus the wagon rental system 1 includes a plurality of wagon controllers 7 in total. The user terminal 8 is held by each user, and thus the wagon rental system 1 includes a plurality of user terminals 8 in total. In another embodiment, the wagons 5 may be held at a plurality of stations 4.

Each user holds and manages the user vehicle 3 by purchasing the user vehicle 3 or renting the user vehicle 3 from a supplier. A prescribed group holds and manages the wagons 5 by purchasing the wagons 5 or renting the wagons 5 from a supplier for the purpose of renting the wagons 5 to each user. The group may be, for example, an agricultural cooperative, a car rental company, a transportation company, or the like. Further, the group may sell or rent out the user vehicle 3 to the user after purchasing the user vehicle 3 or renting the user vehicle 3 from a supplier. The station 4 consists of a parking lot for holding the wagons 5, and is set up and managed by the group. The management server 2 is maintained by the group, the supplier, or a server vendor.

<Wagons 5>

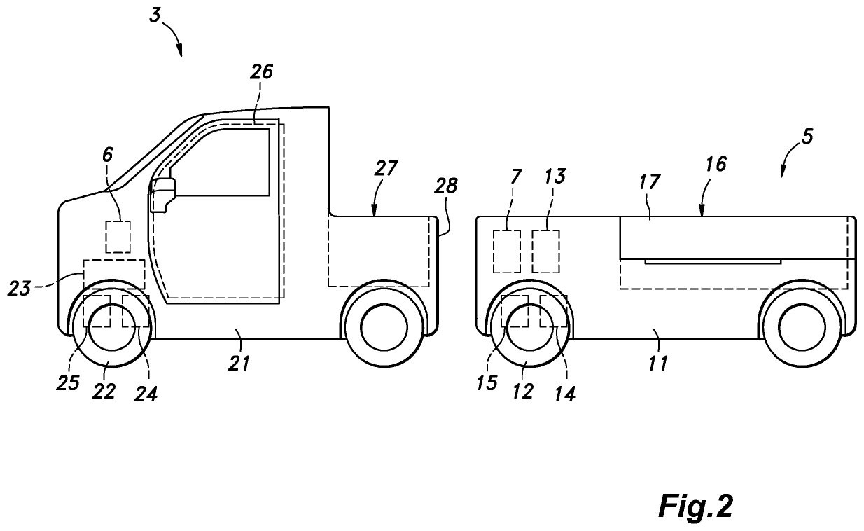

The wagons 5 are held at the station 4, and rented out to the user according to the reservation by the user. As shown in FIG. 2, each wagon 5 consists of a vehicle configured to travel autonomously. Each wagon 5 at least includes a vehicle body 11, a plurality of wheels 12 supported by the vehicle body 11, a driving device 13 that drives the wheels 12, a brake device 14 that decelerates the rotation of the wheels 12, and a steering device 15 that steers the wheels 12. The driving device 13 includes at least one of an electric motor and an internal combustion engine. The brake device 14 may consist of, for example, a disk brake. The steering device 15 may consist of, for example, a rack-and-pinion steering mechanism. A platform 16 is provided on an upper portion of the vehicle body 11. On a left edge, a right edge, and a rear edge of the platform 16, gate plates 17 extending upward are provided respectively. Each gate plate 17 is coupled to the vehicle body 11 via a hinge, and opens a side portion or a rear portion of the platform 16 by rotating. In the present embodiment, the wagon 5 consists of a four-wheeled vehicle. Further, the wagon 5 does not have a vehicle cabin for the occupant (user) to board (enter).

<User Vehicles 3>

The user vehicles 3 are respectively held by the users who use the wagon rental system 1. Each user vehicle 3 at least includes a vehicle body 21, a plurality of wheels 22 supported by the vehicle body 21, a driving device 23 that drives the wheels 22, a brake device 24 that decelerates the rotation of the wheels 22, and a steering device 25 that steers the wheels 22. The user vehicle 3 has a vehicle cabin 26 for the occupant (user) to board (enter). The vehicle cabin 26 may be provided with a driver's seat and a passenger seat. Further, the vehicle cabin 26 may be provided with an operation member (not shown) by which the user operates the driving device 23, the brake device 24, and the steering device 25. The operation member may include, for example, an accelerator pedal, a steering wheel, and a brake pedal. It is preferable that a platform 27 is provided at an upper portion of the vehicle body 21 and behind the vehicle cabin 26. On a left edge, a right edge, and a rear edge of the platform 27, gate plates 28 extending upward are provided respectively. Each gate plate 28 is coupled to the vehicle body 21 via a hinge, and opens a side portion or a rear portion of the platform 27 by rotating. In the present embodiment, the user vehicle 3 consists of a four-wheeled vehicle.

<Wagon Controller 7>

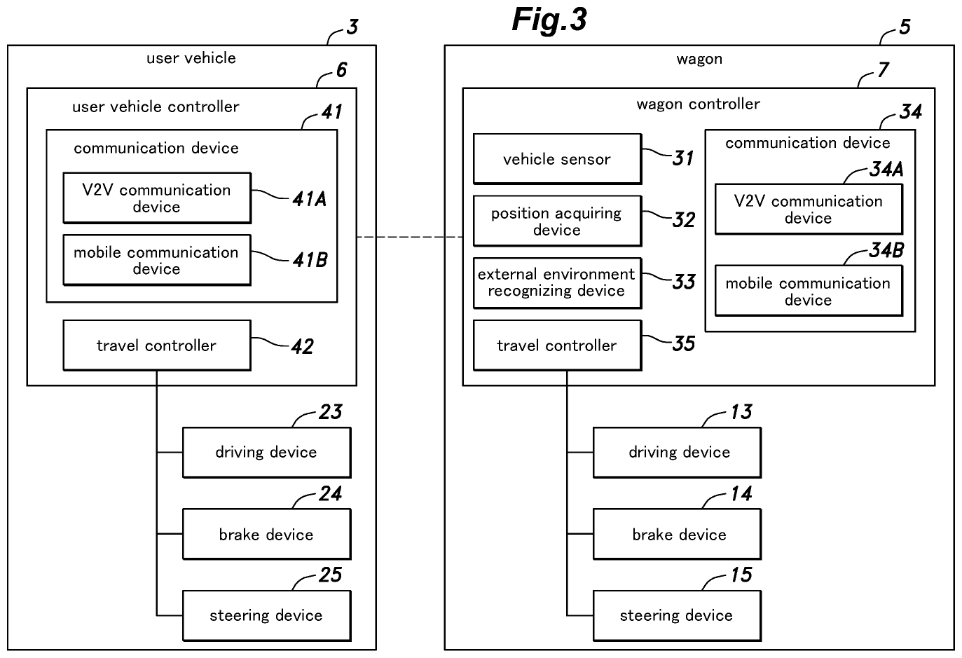

The wagon controller 7 provided in each wagon 5 controls the travel of the wagon 5. The wagon controller 7 performs following control to cause the wagon 5 to follow the user vehicle 3. Further, the wagon controller 7 may perform autonomous travel control to cause the wagon 5 to travel autonomously. As shown in FIG. 3, the wagon controller 7 includes a vehicle sensor 31, a position acquiring device 32, an external environment recognizing device 33, a communication device 34, and a travel controller 35. The vehicle sensor 31, the position acquiring device 32, the external environment recognizing device 33, and the communication device 34 are connected to the travel controller 35 via a communication means such as Controller Area Network (CAN). Hereinafter, an expression “own vehicle” used for the explanation of the components of the wagon controller 7 will indicate the wagon 5.

The position acquiring device 32 is a device that acquires a current position (an absolute coordinate value represented by latitude and longitude) of an own vehicle. The position acquiring device 32 acquires the current position of the own vehicle based on, for example, a GPS signal. The external environment recognizing device 33 is a device for recognizing an object present around the own vehicle. The external environment recognizing device 33 includes, for example, a camera, a radar, a lidar, a sonar, and the like. The object present around the own vehicle includes another vehicle (for example, another wagon 5). Further, the camera included in the external environment recognizing device 33 recognizes an identification code attached to an outer surface of another vehicle.

The vehicle sensor 31 is a sensor that detects a travel state of the own vehicle. The vehicle sensor 31 includes, for example, a vehicle speed sensor that detects the vehicle speed of the own vehicle, an acceleration sensor that detects the acceleration of the own vehicle, an angular velocity sensor that detects a three-axial angular velocity of the own vehicle, an accelerator pedal sensor, a brake pedal sensor, and a steering angle sensor.

The communication device 34 includes a vehicle-to-vehicle communication device 34A (V2V communication device 34A) and a mobile communication device 34B. The vehicle-to-vehicle communication device 34A wirelessly communicates with the user vehicle controller 6 of the user vehicle 3 and the wagon controller 7 of another wagon 5. The mobile communication device 34B wirelessly communicates with a base station of a mobile communication system, and connects the wagon controller 7 to the management server 2 via the Internet 9. The mobile communication device 34B may be based on, for example, a fourth or fifth generation mobile communication system.

The travel controller 35 consists of an electronic control device composed of a computer including a CPU, ROM, RAM, and the like. The CPU of the travel controller 35 performs arithmetic processing according to programs, and thus performs the travel control of the own vehicle by controlling the driving device 13, the brake device 14, and the steering device 15. The travel controller 35 regulates the steering angle of the own vehicle by controlling the steering device 15, and regulates the acceleration, deceleration, and speed of the own vehicle by controlling the driving device 13 and the brake device 14.

The travel controller 35 communicates with the user vehicle controller 6 provided in the user vehicle 3, and thus performs electronic connection control to electronically connect the wagon 5 (more specifically, the wagon controller 7) and the user vehicle 3 (more specifically, user vehicle controller 6) and following control to cause the wagon 5 to follow the user vehicle 3. In the present embodiment, “electronic connection” means a state where the wagon controller 7 of the wagon 5 and the user vehicle controller 6 of the user vehicle 3 can wirelessly communicate with each other and the wagon controller 7 can acquire, from the user vehicle controller 6, information necessary for the wagon 5 to follow the user vehicle 3. In the electronic connection control, the travel controller 35 identifies, based on a use plan (use plan information) received from the management server 2, the user vehicle 3 to which the wagon 5 should be electronically connected, and thus makes the electronic connection. In a state where the electronic connection is made, the travel controller 35 performs the following control to cause the wagon 5 to follow the user vehicle 3. Further, the travel controller 35 performs the autonomous travel control to cause the wagon 5 to travel autonomously.

<User Vehicle Controller 6>

The user vehicle controller 6 provided in the user vehicle 3 performs travel control of the user vehicle 3 according to an operation by the user, and communicates with the wagon controller 7. The user vehicle controller 6 of the user vehicle 3 includes a communication device 41 and a travel controller 42. The communication device 41 includes a vehicle-to-vehicle communication device 41A (V2V communication device 41A) and a mobile communication device 41B. The vehicle-to-vehicle communication device 41A wirelessly communicates with the wagon controller 7 of the wagon 5. The mobile communication device 41B wirelessly communicates with a base station of a mobile communication system, and connects the user vehicle controller 6 to the management server 2 via the Internet 9. The mobile communication device 41B may be based on, for example, a fourth or fifth generation mobile communication system. The travel controller 42 drives the driving device 23, the brake device 24, and the steering device 25 according to a signal from the operation member that receives the operation by the user, and thus performs the travel control of the user vehicle 3.

<Management Server 2 and User Terminal 8>

The management server 2 consists of a computer including a CPU, memory, a storage device, and a communication device, and performs operations according to programs. The user terminal 8 is a computer including a CPU, memory, a storage device, a communication device, and an HMI, and performs operations according to programs. The user terminal 8 includes at least one of an onboard terminal provided in the user vehicle 3 and a smartphone. Further, the user terminal 8 may consist of, for example, a tablet PC, a mobile phone, a PDA, or the like. The HMI of the user terminal 8 is an input/output device such as a touch panel display. The user terminal 8 has an application for communicating with the management server 2 and using the wagon rental system 1. The user terminal 8 transmits various pieces of information (for example, use application information on the wagon 5, autonomous travel application information on the wagon 5, and use end information on the wagon 5) to the management server 2 based on the operation on the HMI by the user.

The use application information is information for applying for the use of the wagon 5, and at least includes the user number, the user vehicle number, the use start place, the use start time, the use end place, and the use end time. The autonomous travel application information is information for causing the wagon 5 to travel autonomously according to the request by the user, and at least includes the user number, the departure place, the destination, and the departure time. The use end information is information for announcing that the user has ended the use of the wagon 5, and includes the user number and the use end request.

The HMI of the user terminal 8 displays an input screen corresponding to each piece of information by the function of the application. At this time, the HMI of the user terminal 8 may communicate with the management server 2 and display the period in which the wagon 5 is available. The user terminal 8 creates one of the use application information, the autonomous travel application information, and the use end information based on the information input by the user, and transmits the created information to the management server 2 via the Internet 9.

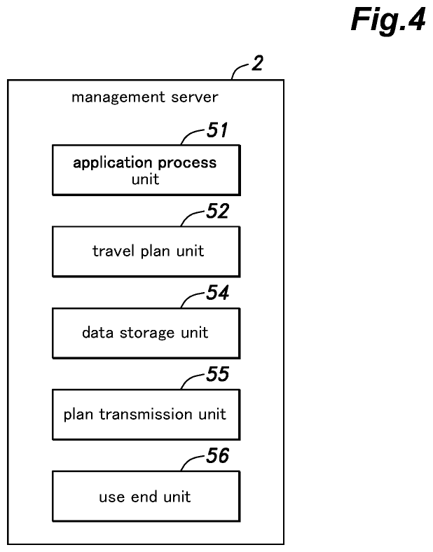

As shown in FIG. 4, the management server 2 includes an application process unit 51, a travel plan unit 52, a data storage unit 54, a plan transmission unit 55, and a use end unit 56. The data storage unit 54 stores a use application table, a use plan table, a user information table, a wagon management table, and a travel plan table. The use application table stores the use application information. The use plan table at least stores, as the use plan information, the use plan number, the user number, the user vehicle number, the use start place, the use end place, the use start time, the use end time, the wagon number of the wagon 5 to be rented out, and the travel plan number of the wagon 5 to be rented out. The user information table at least stores, as the user information, the user number and the user vehicle number. The user information table may further include the address, telephone number, and the like of the user. The wagon management table includes, as the wagon management information, current status information on each wagon 5 and status information on each wagon 5 at each time from the past to the future. The status information on each wagon 5 includes, for example, information such as “standby (rentable)”, “rented out”, “during autonomous driving”, and “under maintenance”. The travel plan table includes, as the autonomous travel plan information on each wagon 5, the travel plan number, the wagon number, and the user vehicle number of the user vehicle 3 the wagon 5 should follow. The autonomous travel plan information is information on an autonomous travel plan of the wagon 5, and includes information on the departure place, the destination, the departure time, the arrival time, and the travel route.

The application process unit 51 determines the wagon 5 to be rented out to the user based on the use application information and the wagon management information, and creates the use plan information. The application process unit 51 may refer to the wagon management table based on the use start time and the use end time of the use application information, extract the wagons 5 whose status information in the period from the use start time to the use end time is set to “standby”, and determine one of the extracted wagons 5 as the wagon 5 to be rented out to the user. At this time, the application process unit 51 may extract (determine) the wagon 5 to be rented out to the user by using “a use start time with a margin” and “a use end time with a margin”. The use start time with a margin may be calculated by advancing the use start time by a prescribed margin time, and the use end time with a margin may be calculated by delaying the use end time by the prescribed margin time. Further, in a case where the use start place in the use application information is different from the station 4, the application process unit 51 may lengthen the margin time according to the distance between the use start place and the station 4, and thus advance the use start time with a margin. Further, in a case where the use end place in the use application information is different from the station 4, the application process unit 51 may lengthen the margin time according to the distance between the use end place and the station 4, and thus delay the use end time with a margin. The application process unit 51 creates the use plan information based on the use application information and the wagon number of the wagon 5 to be rented out to the user, and stores the use plan information in the use plan table.

In a case where the use start place of the use plan information is different from the station 4, the travel plan unit 52 creates the autonomous travel plan for the wagon 5 from the station 4 to the use start place. The travel plan unit 52 sets the station 4 to the departure place, sets the use start place to the destination, and sets the use start time with a margin (the time acquired by advancing the use start time by the prescribed margin time) to the arrival time based on the use start place and the use start time of the use plan information. Further, the travel plan unit 52 sets the departure time of the wagon 5 from the station 4 and the travel route from the departure place to the destination such that the wagon 5 arrives at the destination at the arrival time. The travel plan unit 52 stores the created autonomous travel plan for the wagon 5 in the travel plan table. Further, during the autonomous travel of the wagon 5, the travel plan unit 52 changes the status information on the target wagon 5 in the corresponding period in the wagon management information based on the created autonomous travel plan.

Further, the travel plan unit 52 creates the autonomous travel plan for the wagon 5 in a rental period (a period in which the wagon 5 is rented out) based on the autonomous travel application information received from the user terminal 8. The travel plan unit 52 creates, based on the autonomous travel application information, the autonomous travel plan including the departure place, the destination, the departure time, the arrival time, and the travel route, and stores the autonomous travel plan as the autonomous travel plan information in the travel plan table.

The plan transmission unit 55 transmits the use plan information and the autonomous travel plan information to the wagon controller 7 of the target wagon 5 based on the use plan table and the travel plan table, and transmits the use plan information to the user vehicle controller 6 of the target user vehicle 3.

The wagon controller 7 comes into an electronically connectable state (a state where the wagon controller 7 can be electronically connected to the user vehicle controller 6 of the user vehicle 3 identified by the user vehicle number) in the period from the use start time to the use end time based on the received use plan information. Similarly, the user vehicle controller 6 comes into an electronically connectable state (a state where the user vehicle controller 6 can be electronically connected to the wagon controller 7 of the wagon 5 identified by the wagon number) in the period from the use start time to the use end time based on the received use plan information. The wagon controller 7 and the user vehicle controller 6 may identify each other via short-range communication based on the user vehicle number and the wagon number, which are identification numbers (identification codes) thereof. Accordingly, the wagon 5 becomes able to follow the user vehicle 3.

In a state where the electronic connection is made, the user vehicle controller 6 and the wagon controller 7 transmit to each other the vehicle speed, acceleration, steering angle, accelerator position, brake position, and vehicle position of each vehicle (namely, each of the user vehicle 3 and the wagon 5). In a state of being electronically connected to the user vehicle controller 6 of the user vehicle 3, the wagon controller 7 performs the following control to cause the wagon 5 to follow the user vehicle 3. The wagon controller 7 calculates a travel trajectory of the user vehicle 3, calculates a travel trajectory of the wagon 5 such that the wagon 5 travels while maintaining a prescribed relative position with respect to the user vehicle 3, and controls the driving device 13, the brake device 14, and the steering device 15 of the wagon 5 such that the wagon 5 travels along the created travel trajectory.

The wagon controller 7 may stop the wagon 5 from following the user vehicle 3 based on a signal from the user terminal 8. For example, while the wagon controller 7 is performing the following control, the wagon controller 7 wirelessly communicates with the user terminal 8, and transmits to the user terminal 8 a signal indicating that the following control is being performed. Further, while the wagon controller 7 is performing the following control, the HMI of the user terminal 8 may display a stop button to stop the following control. When the stop button is operated, the user terminal 8 may transmit a stop signal to the wagon controller 7, and the wagon controller 7 may stop the following control according to the stop signal. Further, the HMI of the user terminal 8 may display a following resumption button. When the following resumption button is operated, the user terminal 8 may transmit a following resumption signal to the wagon controller 7, and the wagon controller 7 may resume the following control according to the following resumption signal.

The wagon controller 7 performs the autonomous travel control based on the autonomous travel plan (autonomous travel plan information) received from the management server 2, and starts the autonomous travel of the wagon 5 at the departure time from the departure place to the destination. In the autonomous travel control, the wagon controller 7 calculates a prospective trajectory of the wagon 5 based on the travel route included in the autonomous travel plan, the current position of the wagon 5 acquired by the position acquiring device 32, the position of an obstacle (such as a person and another vehicle) around the wagon 5 acquired by the external environment recognizing device 33, and a travel state (such as the vehicle speed, angular velocity, or the like) of the wagon 5 acquired by the vehicle sensor 31. The wagon controller 7 controls the driving device 13, the brake device 14, and the steering device 15 such that the wagon 5 travels along the prospective trajectory. In the present embodiment, the wagon 5 travels autonomously in sections such as a section from the station 4 to the use start place, a section from the use end place to the station 4, a section from the departure place set by the user to the destination, and the like.

The operation of the wagon rental system 1 configured in this way will be described. The user holds the user vehicle 3, and uses the user vehicle 3 for daily movements and activities. For example, when desiring to transport a cargo that exceeds loading capacity of the user vehicle 3, the user can rent the wagon 5. The user terminal 8 generates the use application information on the wagon 5 according to the operation by the user on the user terminal 8, and transmits the use application information to the management server 2. The management server 2 identifies (determines) the wagon 5 to be rented out to the user based on the use application information of the user, and causes a state where the user can use the wagon 5.

The user can set any use start place of the wagon 5. For example, in a case where the user sets the use start place of the wagon 5 to the station 4, the user drives the user vehicle 3 and goes to pick up the wagon 5 at the station 4 at the use start time. Further, in a case where the user sets the use start place of the wagon 5 to a place (such as user's home) other than the station 4, the wagon 5 autonomously travels from the station 4 to the use start place by the use start time. Accordingly, the user can rent the wagon 5 at the use start place the user has designated.

The user can electronically connect the user vehicle 3 and the wagon 5 and cause the wagon 5 to follow the user vehicle 3 by placing the user vehicle 3 within a prescribed range from the wagon 5 at the use start place on or after the use start time. Accordingly, the user can use the wagon 5 as an extended platform 16 of the user vehicle 3. The user can temporarily stop the following control of the wagon 5 by operating the user terminal 8. Accordingly, the user can stop the wagon 5 at a prescribed place and move the user vehicle 3 independently of the wagon 5. Further, the user can resume the following control of the wagon 5 by operating the user terminal 8.

The user can cause the wagon 5 to travel autonomously to any destination by operating the user terminal 8. The user terminal 8 creates the autonomous travel application information according to the operation on the user terminal 8 by the user, and transmits the autonomous travel application information to the management server 2. The travel plan unit 52 of the management server 2 creates the autonomous travel plan based on the autonomous travel application information, and transmits the autonomous travel plan to the wagon controller 7 of the wagon 5. The wagon controller 7 performs the autonomous travel control based on the autonomous travel plan, and thus the wagon 5 travels autonomously to the prescribed destination. For example, the user can use the autonomous travel of the wagon 5 to move the cargo loaded on the wagon 5 to a prescribed place. For example, in a case where the user is a farmer, the user can load crops on the wagon 5 and transport the crops to a collection point or a store as the destination by using the autonomous travel of the wagon 5.

The user ends the use of the wagon 5 by operating the user terminal 8. The user terminal 8 generates the use end information according to the operation by the user, and transmits the use end information to the management server 2. The use end unit 56 of the management server 2 transmits a use end instruction to the wagon controller 7 based on the use end information. The wagon controller 7 ends, based on the use end instruction, the following control to cause the wagon 5 to follow the user vehicle 3, and maintains the wagon 5 in a use end state. When the wagon 5 is in the use end state, the wagon 5 maintains a stopped state and thus does not follow the user vehicle 3. After that, the wagon controller 7 transmits, to the management server 2, a use end signal (a signal indicating that the wagon 5 is in the use end state) and the current position of the wagon 5. The use end unit 56 of the management server 2 rewrites the current status information on the target wagon 5 in the wagon management table from “rented out” to “standby” based on the use end signal and the current position received from the wagon controller 7, and rewrites the current position to the latest information.

The travel plan unit 52 extracts, based on the wagon management table, the wagons 5 whose current status information is “standby” and whose current position is not located at the station 4. Accordingly, the wagons 5 that have not been returned after the users end the use thereof are extracted. The travel plan unit 52 creates the autonomous travel plan from the current position of the target wagon 5 to the station 4, and transmits the autonomous travel plan to the wagon controller 7 of the target wagon 5. Upon receiving the autonomous travel plan, the wagon controller 7 causes the wagon 5 to travel autonomously to the station 4 based on the autonomous travel plan.

According to the wagon rental system 1 according to the above embodiment, the user rents the wagon 5 as needed and causes the wagon 5 to follow the user vehicle 3 held by the user, thereby enhancing the ability to transport the cargo. The user can drive the user vehicle 3, thereby comfortably transporting the cargo. The wagon controller 7 of the wagon 5 communicates with the user vehicle controller 6 of the user vehicle 3, and identifies the user vehicle 3 the wagon 5 should follow based on the identification code, so that the wagon 5 can be prevented from being electronically connected to an incorrect user vehicle 3 or another vehicle. The user can temporarily stop the wagon 5 from following the user vehicle 3 or end the use of the wagon 5 by operating the user terminal 8.

Since the wagon 5 can travel autonomously, the user can start using the wagon 5 and end the use of the wagon 5 at a desired position different from the station 4. Further, the user can cause the wagon 5 to travel autonomously to a desired destination by operating the user terminal 8. Accordingly, it is possible to transport the cargo or the like to the desired destination in an unmanned way by using the wagon 5. Further, in a case where the use end place is different from the station 4, the wagon 5 travels autonomously to the station 4. Accordingly, the user ends the use of the wagon 5 in a state where the cargo is loaded on the wagon 5, thereby moving the cargo to the station 4 together with the wagon 5. By providing a collection point with the station 4, it is possible to efficiently collect the cargo of the user by using the wagon 5.

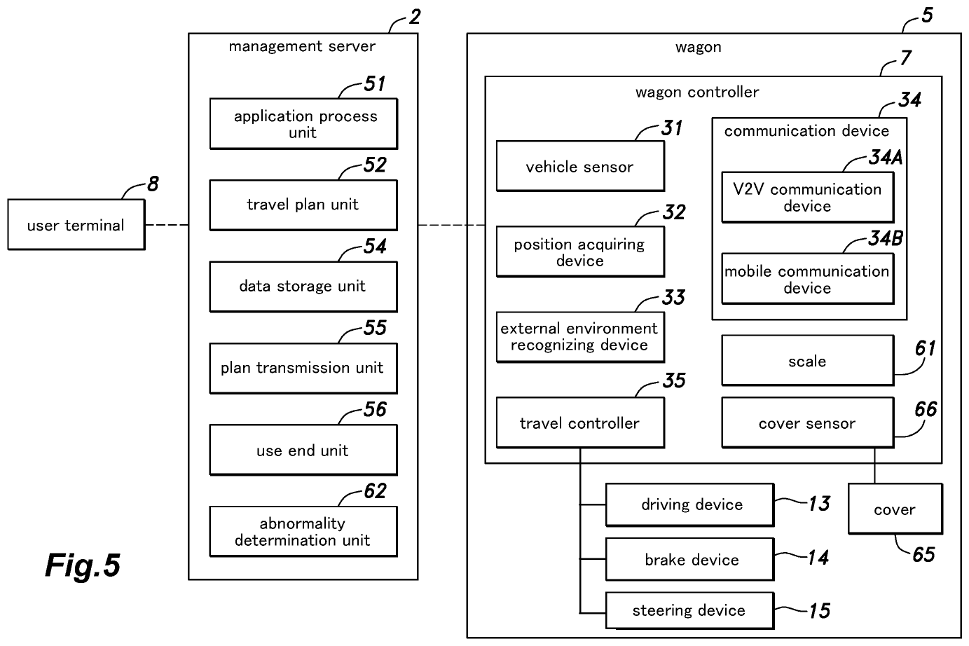

Concrete embodiments of the present invention have been described in the foregoing, but the present invention should not be limited by the foregoing embodiments and various modifications and alterations are possible. For example, as shown in FIG. 5, the wagon 5 may include a cargo monitoring sensor (a scale 61 or a cover sensor 66) configured to monitor the cargo loaded on the wagon 5. The wagon controller 7 may be configured to transmit, to the management server 2, information on a state of the cargo acquired by the cargo monitoring sensor, and the management server 2 may be configured to determine an abnormality of the cargo based on the information on the state of the cargo.

The cargo monitoring sensor may include, for example, a scale 61 configured to measure the weight of the cargo. The scale 61 is provided at the bottom of the platform 16 of the wagon 5 and detects the weight of the cargo loaded on the bottom thereof. The scale 61 may consist of a known load cell or the like. The wagon controller 7 may be configured to transmit the weight of the cargo to the management server 2 at prescribed time intervals. An abnormality determination unit 62 of the management server 2 may record the change in the weight of the cargo at each time, and detect the abnormality of the cargo based on the weight of the cargo. For example, in a case where the decreasing amount of the weight of the cargo from the start of the autonomous travel of the wagon 5 is equal to or more than a prescribed determination value, the abnormality determination unit 62 may determine the abnormality of the cargo. Further, in a case where the changing amount of the weight of the cargo in a prescribed period is equal to or more than a prescribed determination value, the abnormality determination unit 62 may determine the abnormality of the cargo. Accordingly, in a case where the cargo has been stolen or the cargo has fallen from the platform 16 during the autonomous travel of the wagon 5, the abnormality determination unit 62 determines the abnormality of the cargo. Upon determining the abnormality of the cargo, the abnormality determination unit 62 may transmit a notification to the user terminal 8. Further, the management server 2 may transmit information on the weight of the cargo at each time to the user terminal 8.

A cover 65 configured to cover the cargo may be attached to the platform 16 of the wagon 5. The cargo monitoring sensor may include a cover sensor 66 configured to detect an open/close state of the cover 65 configured to cover the cargo. Around the platform 16 of the wagon 5, a locking portion (not shown) such as a hook for locking an end of the cover 65 is provided. The cover sensor 66 may consist of, for example, a switch provided in the locking portion. When the cover 65 is locked by the locking portion, the cover sensor 66 may be pushed by the cover 65 and output an on signal. When the cover 65 is removed from the locking portion, the cover sensor 66 may output an off signal.

The wagon controller 7 may transmit a signal output from the cover sensor 66 to the management server 2. The abnormality determination unit 62 of the management server 2 may record the open/close state of the cover 65 at prescribed time intervals based on the signal output from the cover sensor 66. For example, in a case where the open/close state of the cover 65 changes from a close state to an open state during the autonomous travel of the wagon 5, the abnormality determination unit 62 may determine the abnormality of the cargo. Accordingly, in a case where the cargo has been stolen or the cargo has fallen from the platform 16 during the autonomous travel of the wagon 5, the abnormality determination unit 62 determines the abnormality of the cargo. Upon determining the abnormality of the cargo, the abnormality determination unit 62 may transmit a notification to the user terminal 8. Further, the management server 2 may transmit information on the open/close state of the cover 65 at each time to the user terminal 8.

The autonomous travel function of the wagon 5 is a selective function, and thus may be omitted in a wagon rental system 1 according to another embodiment. In such a case, the travel plan unit 52 of the management server 2 may also be omitted. In such a wagon rental system 1, the user rents the wagon 5 at the station 4 and returns the wagon 5 to the station 4.

The wagon rental system 1 may rent out a plurality of wagons 5 to one user. In such a case, the user may cause one of the plurality of wagons 5 to follow the user vehicle 3, or cause the plurality of wagons 5 to follow the user vehicle 3. In the latter case, the plurality of wagons 5 may be arranged in line behind the user vehicle 3 to follow the user vehicle 3.

1. A wagon rental system, comprising:
a management server;
a plurality of user vehicles held by users;
a plurality of wagons held at a station;
a user vehicle controller provided in each user vehicle;
a wagon controller provided in each wagon and configured to communicate with the management server and the user vehicle controller; and
a user terminal configured to receive an input by each user and transmit a signal corresponding to the input by the user to the management server,
wherein the management server is configured to create a use plan for the wagon based on use application information from the user terminal and transmit the use plan to the wagon controller, and
the wagon controller is configured to cause the wagon to follow the user vehicle based on the use plan when the user vehicle is within a prescribed range from the wagon.

2. The wagon rental system according to claim 1, wherein the wagon controller and the user vehicle controller each have an identification code, and identify each other based on the identification code.

3. The wagon rental system according to claim 1, wherein the wagon controller is configured to stop the wagon from following the user vehicle based on the signal from the user terminal.

4. The wagon rental system according to claim 1, wherein the management server is configured to create a travel plan based on the signal from the user terminal and transmit the travel plan to the wagon controller, the travel plan being created for causing the wagon to travel autonomously to a prescribed destination, and
the wagon controller is configured to cause the wagon to travel autonomously to the destination based on the travel plan.

5. The wagon rental system according to claim 1, wherein the user terminal includes at least one of an onboard terminal provided in the user vehicle and a smartphone.

6. The wagon rental system according to claim 1, wherein the wagon includes a cargo monitoring sensor configured to monitor a cargo loaded on the wagon, and
the wagon controller is configured to transmit, to the management server, information on a state of the cargo acquired by the cargo monitoring sensor, and
the management server is configured to determine an abnormality of the cargo based on the information on the state of the cargo.

7. The wagon rental system according to claim 6, wherein the cargo monitoring sensor includes a scale configured to measure a weight of the cargo, and
the wagon controller is configured to transmit the weight of the cargo to the management server at prescribed time intervals.

8. The wagon rental system according to claim 6, wherein the cargo monitoring sensor includes a cover sensor configured to detect an open/close state of a cover configured to cover the cargo, and
the wagon controller is configured to transmit the open/close state of the cover to the management server at prescribed time intervals.
